(19) United States
(12) Patent Application Publication
(10) Pub. No.: US 2008/0260242 A1
(43) Pub. Date: Oct. 23, 2008

(54) Apparatus and methods for measuring and controlling illumination for imaging objects, performances and the like

(75) Inventors: Nicholas B. MacKinnon, Vancouver (CA); Ulrich Stange, Vancouver (CA)

Correspondence Address: GRAYBEAL, JACKSON, HALEY LLP, 155 - 108TH AVENUE NE, SUITE 350, BELLEVUE, WA, 98004-5973, US

(73) Assignee: Tidal Photonics Inc.

(21) Appl. No.: 11/975,616

(22) Filed: Oct. 19, 2007

Related U.S. Application Data
(63) Continuation of application No. 11/709,340, filed on Feb. 20, 2007, now abandoned.
Application No. 11/709,340 is a continuation of application No. 11/473,506, filed on Jun. 22, 2006, now abandoned.

(51) Int. Cl. G06K 9/00

(52) U.S. Cl. 382/162

(57) ABSTRACT

Scene illumination analysis and control systems and methods that can measure the intensity and wavelength dependent distribution of light illuminating a scene, determine any differences between desired illumination and actual illumination, determine appropriate remedies to adjust illumination and automatically control, and adjust illumination to effect those remedies if desired. Associated software, measurement and control devices, for example appropriate accessories for calibrating the measurement devices, collecting and controlling measurements, analyzing measurements and comparing them to established criteria. The systems and methods can also calculate expected scene illumination based on geographic location, altitude, time of year and day, and weather or other environmental factors, and provides analysis and reports to allow the user to assess scene illumination and plan for in-production or post-production correction of video or film images.

### CROSS-REFERENCE TO RELATED APPLICATIONS

The present application claims priority from U.S. provisional patent application No. 60/281,585, filed Apr. 4, 2001, and from U.S. patent application entitled Apparatus And Methods Relating To Wavelength Conditioning Of Illumination, filed Jan. 31, 2002, Ser. No. 10/061,966, presently pending.

### BACKGROUND

One of the difficult things in photography is to make the picture look the same as real life. It is even more difficult when making a movie or staging a play because the scene being photographed or staged is a re-creation of a real scene. Thus, the light at the re-created scene has to be carefully controlled to mimic the light at the real scene.

Providing accurate lighting is very complex because different scenes in a single movie or play, all shot at the same location or presented on the same stage, can vary from the Arizona desert at midday to dusk in the Amazon jungle with clouds floating by. Additionally, a scene that spans five minutes in a finished film may be shot over a period of several days, with the ambient lighting “on location” at the scene changing constantly yet the finished scene needing to look the same throughout. Providing accurate lighting is still more complex because any single light source, even those that provide all the colors in the rainbow (known as “white light”), typically provides more intense light in some colors than others, for example more red than blue. Other light sources can be chosen to provide only certain color(s), for example substantially only red or blue. In addition, most light bulbs also provide light that is not visible to the naked eye, such as ultraviolet (UV) light and infrared (IR) light, but which can affect the apparent color at the scene.

The lighting at a scene (any illumination, actually) generally has two parts. One is “intensity,” which indicates the strength of the light. Two is “spectrum” which is also known as the “wavelength dependent distribution” of the light, which indicates the various colors that are in the light (for example, a rainbow contains all the colors in the spectrum of visible light, rainbow: violet, blue, green, yellow, orange, and red). There are other ways of dividing or understanding the light, such as multistimulus values and CIE L*A*B*, which are discussed below. Together these features form the relative color characteristic values of the scene. Different colors of light are different wavelengths of light, and range, for example, in the visible spectrum from violet or blue light having a wavelength of about 400 nm to red light having a wavelength of about 700 nm. UV light is typically between about 300 nm to 400 nm, and IR light is typically from about 700 nm to 1000 nm.

Turning to some basic concepts relating to color and color characteristics, light is a form of energy. Various scientific models have described it as either electromagnetic waves or photons. The color of light is related to the amount of energy in the photon or electromagnetic wave. The human eye responds differently to different wavelengths. It is more sensitive to some wavelengths than others: human color vision is trichromatic, which means that the eye substantially detects three overlapping ranges of wavelengths. The brain determines the relative response of the three color-photoreceptors of the eye and interprets this as color. The color response function of the human eye is referred to as a tristimulus function because of the three basic color detection ranges; other sensors can have other multistimulus functions depending on the number of ranges of wavelengths they detect. Commonly used values for the tristimulus functions of human vision are published by the Commission Internationale de l'Eclairage (CIE). Most image recording media such as film or video cameras also detect three ranges of wavelengths, typically comparable or analogous to the wavelength ranges detected by the eye.

In order to obtain particular wavelengths and intensities of light, movie sets employ highly skilled and specialized lighting technicians that use very expensive light bulbs, lighting apparatus, lighting filters (such as colored “gels”), and the like. Other situations likewise employ expensive personnel and apparatus.

Thus, there has gone unmet a need for apparatus, methods such as algorithms, computer implemented programming and the like that analyzes and controls scene illumination. Such apparatus, etc., can measure the intensity and wavelength dependent distribution of light illuminating a scene, determine any differences between desired illumination and actual illumination, determine appropriate remedies to adjust illumination, and automatically control and adjust illumination to provide desired illumination. The present invention satisfies one or more of these needs as well as providing for other needs discussed above or elsewhere herein.

### SUMMARY

The present invention provides lighting analysis and control systems, databases and methods that are particularly useful for shooting movies and lighting theater stages (although the systems, etc., have other uses as well). The systems and such can measure the intensity and wavelength dependent distribution of light illuminating a scene, determine any differences between desired or target illumination and actual illumination, determine appropriate remedies to adjust illumination, and automatically control and adjust illumination to effect those remedies if desired. Indeed, if the systems include or are combined with certain controllable light sources, the systems can provide real-time light adjustment while shooting, thereby adjusting the lights to adapt for changes in ambient light such as changes in the time of day, and even changes in cloud cover, without stopping.

The present invention also provides associated software, measurement and control devices, for example appropriate accessories for calibrating the measurement devices, collecting and controlling measurements, analyzing measurements and comparing them to established criteria. The systems and methods can also calculate expected scene illumination based on geographic location, altitude, time of year and day, and weather or other environmental factors, and provides analysis and reports to allow the user to assess scene illumination and plan for in-production or post-production correction of video or film images.

Thus, in one aspect the present invention provides methods, automated or manual, that control the relative color characteristic values of scene illumination at a scene. The methods can comprise: measuring actual relative color characteristic values of illumination at the scene to provide measured relative color characteristic values; automatically comparing in at least one controller the measured relative color characteristic values with target relative color characteristic values stored in at least one computer-readable database, which can be a relational database if desired; automatically determining in the at least one controller whether there is at least one substantial difference between the measured relative color characteristic values and the target relative color characteristic values; adjusting the illumination characteristics from at least one light source illuminating the scene to provide improved illumination comprise improved relative color characteristic values in the scene illumination that more closely match the target relative color characteristic values.

The methods can further comprise storing the measured relative color characteristic values in at least one computer-readable medium, and the adjusting can be performed automatically. The various measurements can be done using a spectroradiometer, and the target relative color characteristic values can correlate to the relative color characteristics of a specific geographic location. The specific geographic location information can relate to latitude, longitude and altitude, and other color characteristics can correlate to at least one of date, time of day, angle of solar or lunar illumination, cloudiness, rain, dust, humidity, temperature, shade, light from an object in or close enough to the scene that serves as a secondary light source. The light sources can be artificial or natural.

The methods can comprise applying tristimulus or other multistimulus functions to the various relative color characteristic values and for determining at least one appropriate spectral change to correct for the at least one substantial difference between the various relative color characteristic values to provide the improved illumination. The methods can comprise assessing at least one available remedy from a database of available remedies to correct for the at least one substantial difference, and can selectively increase or decrease a substantial amount of red, blue, green or other desired light in the scene illumination, for example by adding or deleting a light source that emits light substantially only in the given wavelength or wavelength band, or by increasing or decreasing the emission intensity of the light source(s). The varying can be accomplished by varying filtering characteristics of at least one variable filter for the light source or by adding or deleting at least one desired filter.

The measured relative color characteristic values and other information can be transmitted via hardwire (e.g., via electrical or optical conductors such wires or fiber optics), wireless, or otherwise as desired, from the spectroradiometer or other sensor or detector to the controller, the light sources and other desired locations.

The methods can further comprise recording the improved relative color characteristic values as a baseline illumination value, and if desired comparing a later-obtained measurement of the relative color characteristic values of the scene illumination against the baseline illumination value to determine if the later-obtained measurement varies more than a threshold level from the baseline illumination value. If the later-obtained measurement varies more than the threshold level from the baseline illumination value, then the scene illumination can be adjusted to bring the relative color characteristic values within the threshold level.

In another aspect, the present invention provides automated methods that control relative color characteristic values of illumination of a scene, comprise: measuring actual relative color characteristic values of illumination at the desired scene to provide measured relative color characteristic values and storing the measured relative color characteristic values in at least one computer-accessible database; automatically comparing in at least one controller the measured relative color characteristic values with target relative color characteristic values stored in at least one computer-readable database; automatically determining in the at least one controller whether there is at least one substantial difference between the measured relative color characteristic values and the target relative color characteristic values; adjusting the recording characteristics of at least one recording imaging device such as a CCD camera that is recording an image of the scene, to provide improved apparent illumination comprising improved relative color characteristic values of the scene illumination as recorded by the recording device that more closely match the target relative color characteristic values. As noted elsewhere, this and all other aspects, features and embodiments of the invention can be permuted, combined or otherwise mixed as desired.

In a further aspect, the present invention, provides methods of making a database comprising target relative color characteristic values for a desired geographic position, a desired date and time, an environmental condition such as cloudiness, rain, dust, humidity, temperature and shade, and glare.

The methods comprise: determining a wavelength dependent energy distribution for solar illumination for the desired geographic position based on a latitude, longitude and altitude of the desired geographic position, or for the angle of the sun based on the time of day, or other specific information for the particular condition such as the depth of the clouds for cloudiness; calculating appropriate relative color characteristic values of the wavelength dependent energy distribution for the desired characteristic using multistimulus values, to provide the target relative color characteristic values for the desired characteristic; and recording the target relative color characteristic values as the database in a computer-readable database. The methods can also use such a database for selecting target relative color characteristic values for a scene illumination, comprising reviewing appropriate relative color characteristic values in the database, identifying a target appropriate relative color characteristic value corresponding to the target relative color characteristic values, and selecting the target appropriate relative color characteristic value.

In still another aspect, the present invention provides methods of identifying illumination equipment to illuminate a desired scene, comprising providing target relative color characteristic values for the desired scene; providing a computer-readable database comprise known relative color characteristic values for a plurality of illumination equipment at least one of which can be able to supply the target relative color characteristic values; comparing the target relative color characteristic values to the database; and, identifying acceptable illumination equipment able to supply the target relative color characteristic values. The illumination equipment can be selected from the group consisting of a white light source, a tunable light source, a light filter, a wavelength dispersive element, a spatial light modulator, and a light source emitting a single wavelength or a wavelength band limited to single color of light. The target relative color characteristic values can be obtained from a database as discussed herein.

Methods of establishing scene baseline values comprising target relative color characteristic values of illumination of a scene illumination can include: illuminating a scene; measuring actual scene illumination; calculating the relative color characteristic values of the actual scene illumination to provide measured relative color characteristic values; and recording the measured relative color characteristic values in a computer-readable medium as scene baseline values. The methods can comprise, between the calculating and the recording, comparing the measured relative color characteristic values to target relative color characteristic values and determining whether there is at least one substantial difference and adjusting the actual scene illumination until the actual scene illumination surpasses a desired value to provide an acceptable actual scene illumination, and the recording can comprise recording the acceptable actual scene illumination as scene baseline values.

Computer-implemented methods of adjusting illumination of a scene after measurement of unacceptable tristimulus or other multistimulus values of relative color characteristic values of the scene can comprise: providing the measurement comprising the unacceptable multistimulus values; comparing the unacceptable multistimulus values to a range of dynamic adjustment capabilities of illumination equipment that are illuminating the scene; and automatically or manually adjusting the illumination equipment under feedback control until the multistimulus values of the scene reach an acceptable level.

The present invention also provides computer-implemented programming that performs the methods herein, computers and other controllers that comprise computer-implemented programming and that implement or perform the methods herein, and systems for illuminating of a scene comprise: a spectral sensor and a controller as discussed herein operably connected to the spectral sensor, and preferably at least one light source operably connected to the controller and capable of variably affecting the spectral composition of the illumination. The systems can be hardwire, wireless or otherwise as desired, and the light sources can include at least one light source that emits primarily red light, at least one light source that emits primarily green light, and at least one light source that emits primarily blue light, or at least one white light source, or a tunable light source, either or both in terms of intensity or wavelength.

These and other aspects, features and embodiments of the invention are set forth within this application, including the following Detailed Description and attached drawings. In addition, various references are set forth herein, including in the Cross-Reference To Related Applications, that discuss in more detail certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 provides a schematic view of a movie scene wherein the illumination is controlled by a system according to the present invention.

FIG. 2 provides a schematic view of a movie scene wherein the illumination is controlled by a system according to the present invention and wherein certain components are operably connected by wireless communications.

FIG. 3 provides a schematic view of a movie scene wherein the illumination is controlled by a system according to the present invention and wherein certain components are operably connected by wireless communications, certain components are operably hardwired, and solar illumination is present.

FIG. 4 provides graphs of the wavelength dependent energy distribution of the scene illumination from xenon lamps (black line) and of the wavelength dependent energy distribution of the scene illumination from the red, green, and blue spectral conditioning lamps.

FIG. 5 depicts a graph showing the sum of the wavelength dependent energy distribution of the scene illumination from multiple lamps.

FIG. 6 depicts the effect on the wavelength dependent energy distribution of scene illumination as depicted in FIGS. 1-3 wherein the red, green, and blue balancing lamps have been adjusted for maximum output.

FIG. 7 depicts the effect on the wavelength dependent energy distribution of scene illumination as depicted in FIGS. 1-3 wherein the green lamp has been adjusted to 50% of maximum intensity.

FIG. 8 depicts the effect on the wavelength dependent energy distribution of scene illumination as depicted in FIGS. 1-3 wherein the red lamp has been adjusted to 50% of maximum intensity.

FIG. 9 depicts the effect on the wavelength dependent energy distribution of scene illumination as depicted in FIGS. 1-3 wherein the blue lamp has been adjusted to 50% of maximum intensity.

FIG. 10 depicts a tristimulus function incorporated into the determination of the illumination emitted by a typical xenon lamp.

FIG. 11 depicts a tristimulus function incorporated into the determination of the illumination emitted by a typical xenon lamp in combination with red, green, and blue balancing lamps.

FIG. 12 depicts a tristimulus function incorporated into the determination of the illumination emitted by a typical xenon lamp in combination with red, green, and blue balancing lamps wherein the blue lamp is emitting at 50% intensity relative to FIG. 11.

FIG. 13 depicts a tristimulus function incorporated into the determination of the illumination emitted by a typical xenon lamp in combination with red, green, and blue balancing lamps wherein the red lamp is emitting at 50% intensity relative to FIG. 11.

FIG. 14 is a flow chart depicting an embodiment of an algorithm for determining characteristic color values expected for a scene at a desired geographic position at a desired time and under desired or actual environmental conditions.

FIG. 15 is a flow chart depicting an embodiment of an algorithm for selecting equipment to illuminate a scene.

FIG. 16 is a flow chart depicting an embodiment of an algorithm for setting up the illumination at a scene to try to reproduce a desired illumination for human viewing.

FIG. 17 is a flow chart depicting an embodiment of an algorithm for the final setup of illumination for a scene that is being recorded by a camera or other imaging device.

FIG. 18 is a flow chart depicting an embodiment of an algorithm for control of the lighting and camera equipment to maintain constant color during the viewing or recording of the scene.

FIG. 19 is a flow chart decision tree depicting an embodiment of an algorithm for adjusting the illumination after measurement of the tristimulus or other multistimulus values.

### DETAILED DESCRIPTION

The present invention provides a variety of methods, systems, apparatus, etc., that can carefully and rapidly control scene lighting. Such control saves time and money when shooting movies, and also enhances the ability to make the scene look the way the photographer wants it.

Definitions

The following paragraphs provide definitions of some of the terms used herein. All terms used herein, including those specifically discussed below in this section, are used in accordance with their ordinary meanings unless the context or definition indicates otherwise. Also unless indicated otherwise, except within the claims, the use of “or” includes “and” and vice-versa. Non-limiting terms are not to be construed as limiting unless expressly stated (for example, “including” means “including without limitation” unless expressly stated otherwise).

Measurement of light with an intensity and wavelength calibrated spectrometer can be referred to as spectroradiometry. Relating spectroradiometric measurements to the observer-characteristics of the human eye can be referred to as photometry. Measurements may comprise, for example, absolute optical intensity, relative optical intensity, optical power, optical energy, illuminance, radiance, irradiance, and transmittance and may be made over a plurality of discrete wavelengths or wavelength regions.

Absolute optical intensity is a measurement of the number of photons striking a given area for a given period of time. It can be expressed in a variety of combinations of units. Relative optical intensity is the relative intensity of one measurement to another measurement. A common example of this would be the comparison or ratio of the measured intensity at one wavelength relative to the measured intensity at another wavelength.

Unless otherwise indicated, expressly or implicitly, terms relating to measurement and characterization of light can be defined by reference to the Handbook of Optics, CD-ROM Second Edition, sponsored by the Optical Society of America and published by McGraw-Hill, 1996, preferably definitions found in Volume II, Chapters 24 and 25.

A “controller” is a device that is capable of controlling light sources, detectors, light attenuation apparatus, or other elements of the present invention. For example, the controller can control a light spectrum or intensity detector, such as a spectrometer or spectroradiometer, a non-pixelated or pixelated light detector (such as a charge coupled device (CCD), charge injection device (CID), complementary metal oxide semiconductor (CMOS), or photodiode array, avalanche photodiode array, photomultiplier tube (PMT), any other desired spectral measuring device, a light source such as a tunable light source, and/or compile data obtained from the detector, including using such data to make or reconstruct images or as feedback to control a light source. Typically, a controller is a computer or other device comprising a central processing unit (CPU) and capable of implementing computer-readable programming such as algorithms and software. Controllers are well known and selection of a suitable controller for a particular aspect is routine in view of the present disclosure.

The scope of the present invention includes both means plus function and step plus function concepts. The terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim. The present invention comprises multiple aspects, features and embodiments including methods, apparatus, systems and the like; such multiple aspects, features and embodiments can be combined and permuted in any desired manner unless other expressly stated or clear from the context.

Other terms and phrases in this application are defined in accordance with the above definitions, and in other portions of this application.

### The Figures

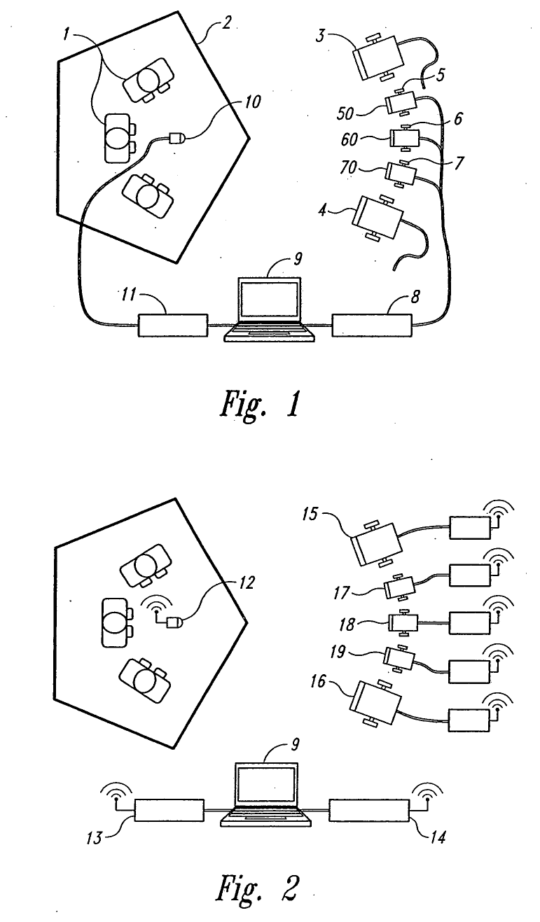

Turning to the Figures, FIG. 1 depicts schematically a scene with actors that could be filmed or photographed. The actors 1 are placed in the scene 2 indicated by an irregular pentagon. The scene is illuminated by two xenon arc lamps 3, 4 that provide the primary white light illumination, but are not under computer control. The scene is also illuminated by three arc lamps 5, 6, 7 equipped respectively with red 50, green 60, and blue 70 optical filters. These lamps are under the control of a lamp manager 8 which is operably connected to a computer 9. Prior to or simultaneous with filming, photographing, performing, or otherwise doing something at a scene comprising specified illumination, the light illuminating the scene 2 from the lamps 3-7 is measured by a color measurement spectroradiometer sensor 10, which is operably connected to a measurement system manager 11 which is further operably connected to the computer 9. Sensor 10, manager 11 or computer 9 can be discrete or integrated devices. Sensor 10 typically detects both spectral responses and illumination intensity; a plurality of sensors can be used if desire. Additionally, the sensor(s) can be incorporated into scene props, such as a chair, rock, plant stand, an actor's clothing, or anything else in the scene. This can be advantageous to prevent the need to place the sensor in the scene for measurements and then remove the sensor from the scene when the measurement is completed or alternatively it can provide for continuous monitoring and control of illumination.

When desired, for example when initiated by a human operator just prior to filming, the system measures the illumination and compares it to a desired or baseline (target) illumination. If the measured value is outside the range of the desired values, the software analyzes whether adjustment of the intensity of the red, green, blue or xenon lamp(s) (or other desired lamps, filters, etc.), which can be under computer control, can correct the illumination. If adjustment will correct the illumination the lighting can be adjusted automatically until it is within the range of the desired value and the operator will be notified, for example via the software user interface. If the lighting cannot be automatically adjusted within the range of the desired values, or if manual adjustment is preferred for any reason, the operator will be notified, for example via the software-user interface, so manual adjustment may be effected.

FIG. 2 depicts a similar system where the wireless measurement device sensor 12 is equipped with a wireless communication system such as a radio, cellular telephone, or free space optical communication system. Wireless measurement device manager 13 is also equipped with such a communication system. This manager may be separate from or integrated with system computer 9. Computer 9 is operably connected to the wireless lamp system manager 14, which is equipped with a wireless communication system that connects it to white light xenon lamps 15, 16 and to red, green, and blue filtered xenon lamps 17, 18, 19.

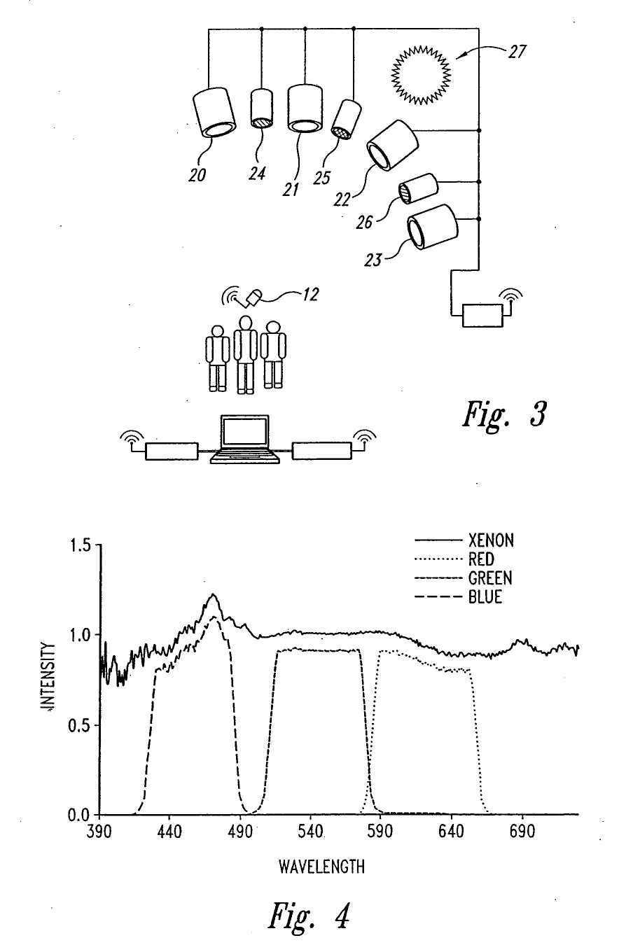

FIG. 3 shows a schematic representation of a scene being filmed with slightly more complex illumination. In FIG. 3, the scene is out of doors and is illuminated by natural solar illumination 27, or sunlight, as well as by four white light xenon lamps 20-23, one each of a red 24, green 25, and blue 26 lamp, all under computer control. The scene lighting is set up and adjusted as discussed above to an acceptable desired or baseline illumination. During the course of the day, movement of the sun and changes in weather vary the relative contribution of solar illumination. Prior to filming each scene, or during such filming, the operator can activate the automatic control which can adjust the lighting to correct for this variation and bring the illumination back to baseline, thus minimizing the need for post-production laboratory processing to correct color changes as well as reducing the time for manual intervention on the film set. Thus, if desired it is possible to shoot an entire scene over the course of a full day with substantially reduced down time.

The sensor can be arranged such that it continuously senses the light at the scene (for example the detector or sensor can be incorporated into a prop) throughout the filming of the scene. If the scene lighting includes variable light sources or light attenuators (such as filters or gels), which variability can be continuous or discrete, then the manager or other controller can automatically (or manually) vary the lighting to compensate for the changing lighting conditions. Such variance can be performed substantially in real-time so that the apparent illumination in the camera or other imaging device remains constant (or varied in accordance with desired or target variances) throughout the scene(s). Some suitable light sources for such a system are disclosed in the U.S. patent application filed Jan, 31, 2002, Ser. No. 10/061,966.

There are a variety of methods for adjusting the intensity of a lamp, including both automatic and manual methods. The intensity of a lamp can be controlled by adjusting the voltage or current supplied to the lamp, by adjusting the opening of an iris, which can be motorized, or moving under motor control various apertures between a light source and the scene. Alternatively, the intensity can be adjusted by controlling a digital micromirror (DMD), a liquid crystal filter, or other spatial light modulator combined with a lamp(s) to control the output intensity. See, e.g., U.S. patent application filed Jan. 31, 2002, Ser. No. 10/061,966. The light sources or luminaires can also be turned on/off, or moved, either manually or automatically, for example along a track system, or otherwise adjusted to provide a desired shadow.

In one embodiment of the invention the main scene illumination is from white light xenon arc lamps or high intensity discharge HID lamps with computer controlled intensity adjustment provided by a motorized iris aperture. The scene illumination color balance is provided by adjustment of one or more each of a red filtered xenon arc lamp, a blue filtered xenon arc lamp and a green filtered xenon arc lamp that are under computer control for intensity. In another embodiment of the invention, as depicted in FIG. 3, the main scene illumination is from white light xenon arc lamps 20-23 and the scene illumination color balance is provided by adjustment of one or more each of a red filtered xenon arc lamp 24 and a green filtered xenon arc lamp 25 and a blue filtered xenon arc lamp 26 that are under computer control for intensity. As the solar illumination 27 varies during the day the color change may be compensated for by varying the intensity of these lamps.

FIG. 4 depicts graphs of the wavelength dependent energy distribution of the scene illumination from the xenon lamps (black line) and of the wavelength dependent energy distribution of the scene illumination from the red, green, and blue spectral conditioning lamps (red, green, and blue lines, respectively) as measured at the wireless sensor 12 from FIG. 3. The solid line graph in this figure shows the typical lamp spectra of xenon lamps used in the production of motion pictures. The red, blue and green graphs show the spectra of three such lamps equipped with an optical filter that transmits with about 90% efficiency in each of the red, blue and green bands.

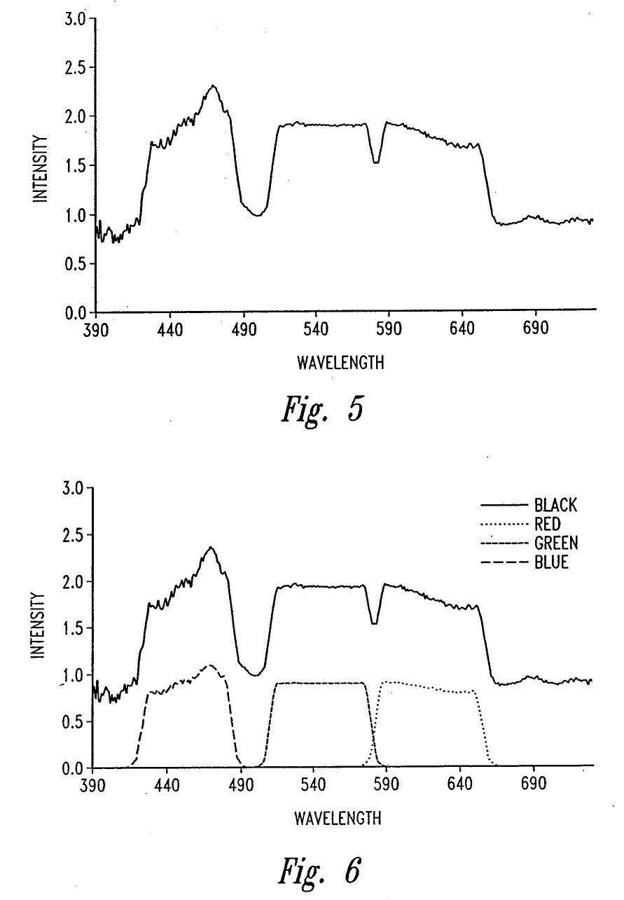

FIG. 5 depicts a graph showing the sum of the wavelength dependent energy distribution of the scene illumination from all lamps as measured from the wireless sensor 12 from FIG. 3. The solid line in this Figure shows typical lamp spectra of an unfiltered xenon lamp used to illuminate a scene, in combination with three additional lamps equipped with an optical filter that transmits with about 90% efficiency in one of the red, blue and green bands. These lamps therefore provide independently controllable red, green or blue illumination that can be used to modify the color balance of the scene being illuminated

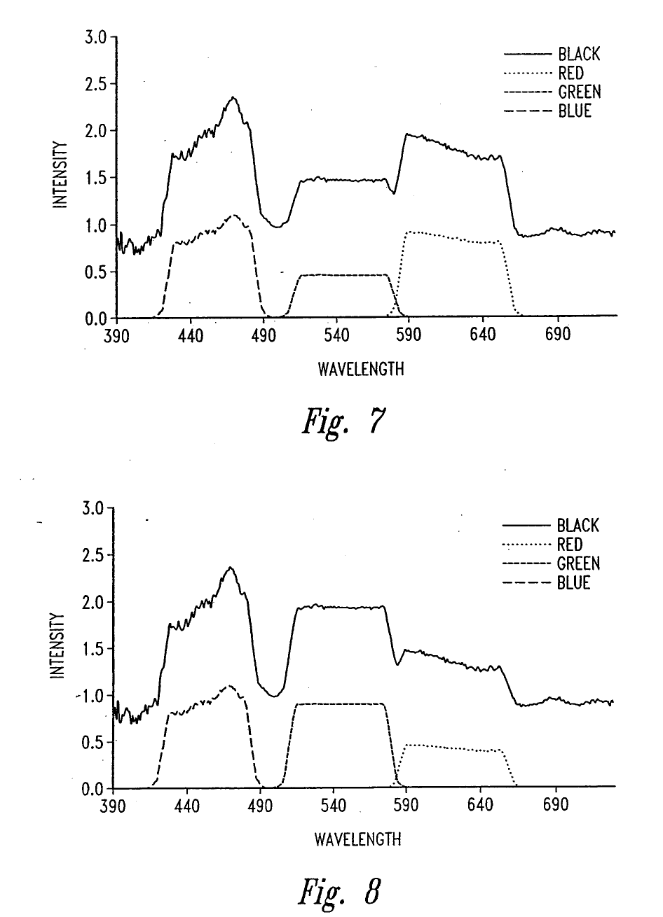

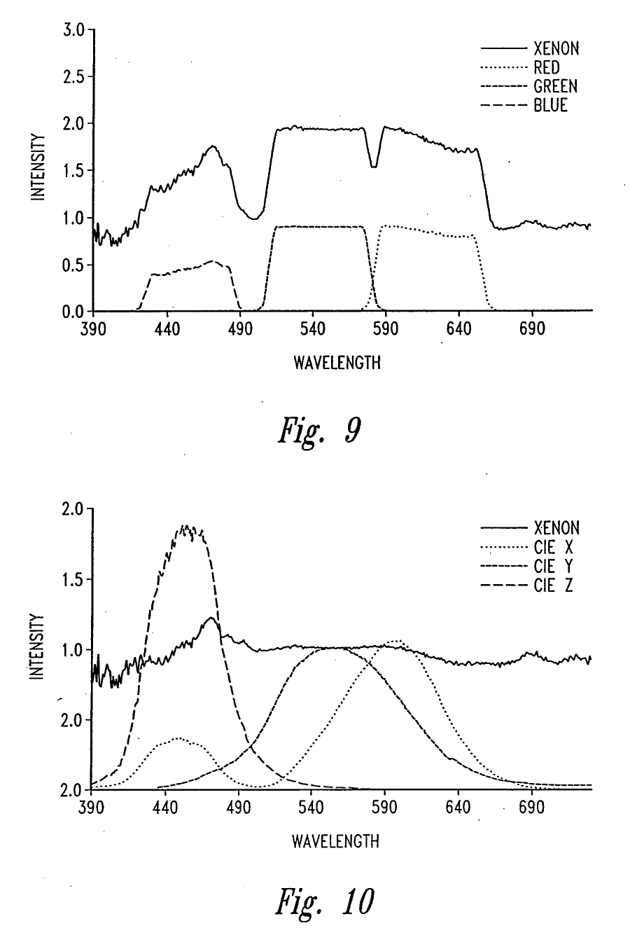

FIGS. 6-9 depict the effect on the wavelength dependent energy distribution of the scene illumination for various adjustments of the red, green, and blue color balancing lamps. FIG. 6 shows all three red, green, and blue lamps adjusted for maximum output and the perceived color would be near to white. The solid line in this picture shows the resultant combination lamp spectra of xenon lamps combined with three spectral conditioning lamps that could be used in the production of motion pictures. The red, blue and green lines show the spectra of three such lamps equipped with an optical filter that transmits with about 90% efficiency in either the red, blue and green bands. FIG. 7 shows the red and blue lamps at maximum output and the green lamp adjusted to 50% of maximum output, shifting the perceived color of the illumination toward red-blue or purple. FIG. 8 shows the green and blue lamps at maximum output and the red lamp adjusted to 50% of maximum output, shifting the perceived color of the illumination toward blue-green. FIG. 9 shows the green and red lamps at maximum output and the blue lamp adjusted to 50% of maximum output, shifting the perceived color of the illumination toward yellow.

The combinations of white light and colored lamps discussed above and elsewhere herein illustrate two embodiments of the invention. Many combinations of wavelength regions could be used. For example, a white light source filtered to produce five wavelength ranges can be used for additive mixing to create a spectral signature, or any desired plurality of wavelength regions could be used to create a spectral signature.

In one embodiment the present invention relates to perceived color control via use of a tristimulus function or color response function or similar integrative methodology that combines perceived color with the wavelength-dependent characteristics of an object, light source, or scene. Some background may be helpful. The effect of illumination changes on perceived color results from interaction of a) the illuminating light reflected or otherwise emitted from an object with b) the image sensor, along with any subsequent processing of the signal. The image sensor may be the human eye, a photographic film, a CCD, CID, CMOS (or other pixelated detector), or some other type of image sensor. The signal processing may be, for example, the neural network of the human nervous system, typically the nerves connecting the brain to the rods and cones of the eye, or it may be the electrical circuits and components of an imaging device. The cones or color receptors of the human eye in combination with the neural network of the retina respond to light in a characteristic way to produce 3 sensed signals that are then processed into 3 perceptual signals. This response function is well documented by the CIE and other organizations.

Applying one of the CIE tristimulus functions, such as the 2-degree standard observer, to the spectrum of a light source can produce 3 numbers that can define the color of a light source. By modifying the relative amounts of red, green, and blue light in a light source, a variety of spectral signatures can be created. If the spectral signature is modified to produce the same color response function values as a desired type of illumination, color appearance will be similar. The closer the spectral shape resembles the spectral shape of the desired illumination, the more exact will be the color reproduction or rendition.

Typically the tristimulus function relates to red, green, and blue. It can alternatively relate to other three-color systems, such as red, orange, yellow or orange, yellow, blue or to any other combination of colors as desired. In addition, similar functions can incorporate two, four, five, or other color combinations as desired to provide a multistimulus function. An example of a pentastimulus function relates to red, yellow, orange, green, blue.

The light sources can be “tuned,” either literally or figuratively, via the use of filters or the other optical elements, to substantially reproduce the spectral signature of a desired illumination, which will thus also have substantially the same color response function values as the desired illumination. In another embodiment the light sources can be tuned to produce the same color response function values as the desired illumination, even though the spectral signature will be different. The invention software can analyze both the color response function values and the spectral signatures to optimize illumination adjustment and calculate indicators of the quality of illumination matching.

The tristimulus function of the human eye is also useful for imaging devices such as film cameras or video cameras because many cameras incorporate optical filters in either the film or the image sensor that have a color response similar to the tristimulus function of the human eye. Just as the human eye and brain reduce a range of optical energies to two, three or more discrete values that are representative of a color and/or intensity of light, so can other imaging devices and color measurement devices. Commercially available cameras (JAI America Inc, Laguna Hills, Calif.) can be equipped with optical filters that allow them to detect and encode wavelengths as red, green and blue light, or they can be equipped with filters that respond to cyan, yellow and magenta light. Other desired optical filters are used for various specialized applications. Mathematical transforms or signal processing functions can also convert measured values into derived values such as the L*, a*, b* luminance and chrominance used in some of the CIE models of human color perception, or they may be particular values characteristic of a photographic film or video camera. A tristimulus function, multistimulus function, or other color response function, is any function that represents or that uses optical, electronic or mathematical operations to detect or transform a range of wavelengths and intensities of light into two or more signals or digital values that represent or indicate that distribution of light.

Software provided herein comprises databases of the tristimulus functions, or other desired multistimulus functions or color response functions, for one or more imaging devices arid media or algorithms for generating such information from device calibration measurements or device profiles such as the ICC color profiles of a device. Software provided herein comprising algorithms for matching the set of characteristics of the target scene illumination and on-site scene illumination using values calculated from a tristimulus, or other, function of the imaging device or media can ensure that illumination and color seen by the imaging device is consistent.

FIGS. 10-13 depict various situations where a tristimulus function has been incorporated into the determination of the illumination emitted by various light sources, in order to provide a scene illumination light having a desired spectral distribution and intensity. In FIG. 10, the solid line shows the lamp spectra of a typical xenon lamp. The red, blue and green graphs show the application of the CIE 2 degree Standard Observer tristimulus response function to the light source. The tristimulus value is the normalized integral of each of the red, green and blue curves. For this source it is X=97.97, Y=100, Z=101.46. In FIG. 11, the solid line shows the resultant combination lamp spectra of xenon lamps combined with three spectral conditioning lamps, red, blue and green. The red, blue and green graphs show the application of the CIE 2 degree Standard Observer tristimulus response function to the light source. The tristimulus value is the normalized integral of each of the red, green and blue curves. For this source it is X=99.62, Y=100, Z=99.29.

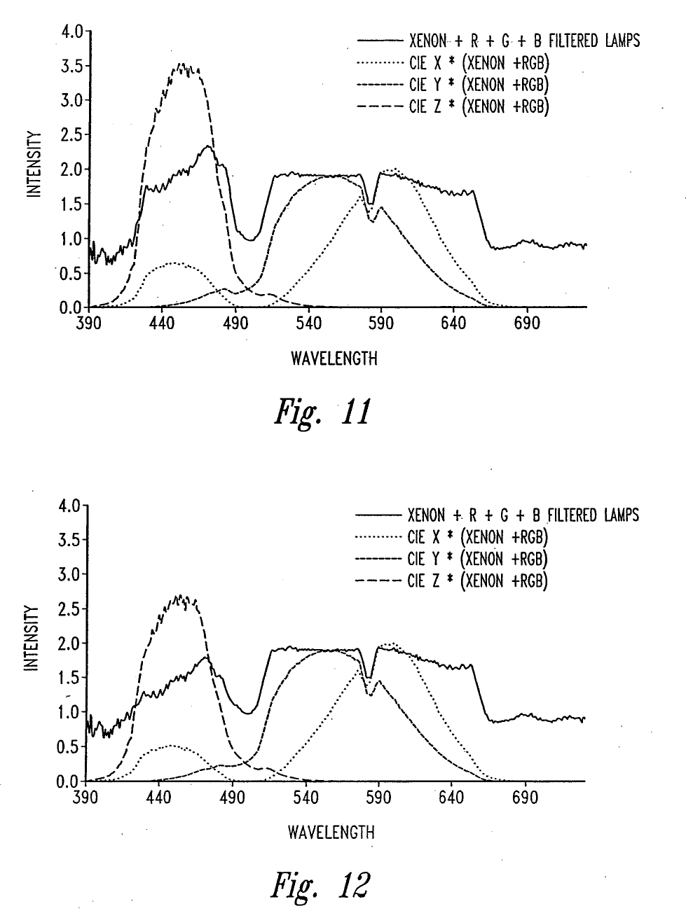

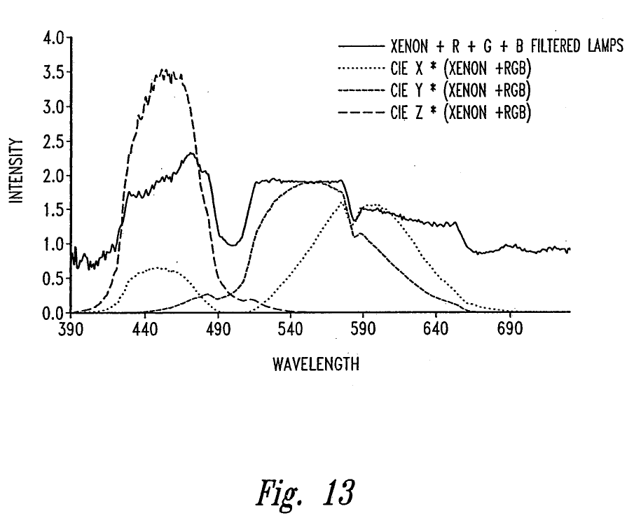

In FIG. 12, the solid line shows the resultant combination lamp spectra of xenon lamps combined with three red, blue and green spectral conditioning lamps. The blue conditioning lamp has had its intensity reduced by 50%. The red, blue and green graphs show the application of the CIE 2 degree Standard Observer tristimulus response function to the combined illumination. The tristimulus value is the normalized integral of each of the red, green and blue curves. For this illumination it is X=96.88, Y=100, Z=79.14. In FIG. 13, the solid line shows the resultant combination lamp spectra of xenon lamps combined with three red, blue and green spectral conditioning lamps where the red conditioning lamp has had its intensity reduced by 50%. The tristimulus value is the normalized integral of each of the red, green and blue curves, and for this illumination is X=93.57, Y=100, Z=106.33.

In some aspects and embodiments the present invention provides for databases, algorithms and procedures useful for prediction, measurement, analysis, control and recording of scene illumination.

The databases comprise any desired combination of geographic information, information concerning the position and movements of the sun and moon, information about environmental conditions and environmental effects, on solar, lunar and artificial illumination, information on the color transduction characteristics of human vision, cameras and various media such as film, including tristimulus functions, illumination readings from a variety of locations at a variety of times of day and year, at various times of year, and information on the color affecting characteristics of equipment. Equipment information includes but is not limited to the wavelength dependent illumination, transmission or reflectance characteristics of lamps and light sources, optical filters such a glass filters or gels, information with respect to the interface and control characteristics of devices used for scene illumination or imaging as well as information related to the costs of equipment, time, or consumables. Databases can also include information related to logistics such as sequence of scene filming, calendar requirements for equipment, calibration and quality control information, recording and associating measurements, and illumination adjustments with particular images or image sequences. The invention also comprises apparatus and methods for creating, maintaining and updating such databases.

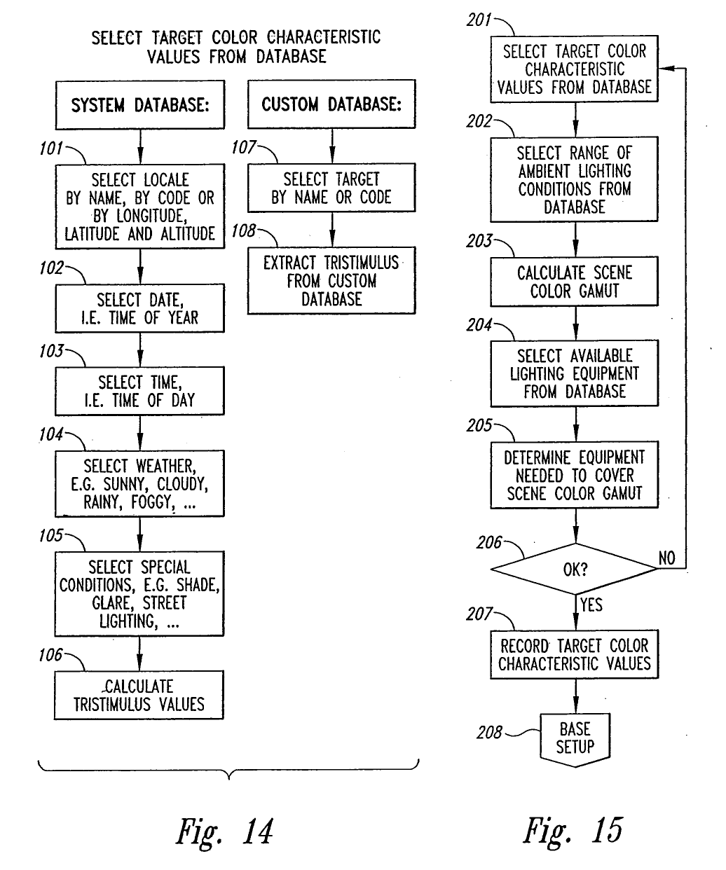

FIG. 14 is a flow chart depicting an embodiment of an algorithm of the computer implemented programming for determining the characteristic color values expected for a scene at a desired geographic position at a desired time and under desired or actual environmental conditions. The algorithm provides methods for calculating the wavelength dependent energy distribution or spectrum of the illumination expected, from the input data provided. For example, the spectrum of sunlight is known. From the input data of geographic location 101 such as latitude, longitude and altitude, as well as date 102 and time 103, the angle and direction of the solar illumination can be determined by the software. Once the angle and direction of the solar illumination has been determined, the amount of atmosphere it will be transmitted through can be determined and the effect of atomic or molecular visible light absorption on the illumination can be calculated by the software. If the environmental conditions are known and input, the effect of atmospheric conditions 104, such as clouds, rain, dust, humidity, and temperature, can also be used by the software to calculate the effect of additional absorption or scattering on the illumination expected. Additionally, the effect of special ambient conditions 105 such as shade from foliage, or from reflections and glare from natural or artificial light sources may be included in the software calculation of the expected illumination. Once the expected wavelength dependent energy distribution or spectrum of the illumination is determined, then the appropriate color characteristics of the illumination spectrum, such as the CIE tristimulus values, can be calculated 106. FIG. 14 also depicts an alternative algorithm for extracting characteristic color values from a database created from previously measured or calculated characteristic color values. In such a database, all that need be done is to select 107 a target location or scene by name, code, or other identifying features (such as latitude and longitude) and then extract 108 the relevant, tristimulus values from the database. The tristimulus values (or other multistimulus values) can be determined, for example, either empirically by measuring the light at the location or theoretically by figuring the values based on expected sunlight angle, altitude, etc.

FIG. 15 is a flow chart depicting an embodiment of an algorithm of the computer implemented programming for selecting equipment to illuminate a scene. The desired or target illumination target color values are selected 201 from a database of known desired illumination values or calculated using the database of geographic information, celestial and environmental information. The range of ambient lighting conditions for the place to be illuminated is selected 202 from a database or calculated from known values. Examples of ambient lighting conditions include natural illumination of an outdoor scene where a motion picture is being shot or the background lighting of a movie sound stage. The color gamut of the scene illumination is calculated 203 for the range of ambient scene illumination and the desired scene illumination. The available equipment is selected 204 from the equipment database. Examples of available equipment can include the equipment available from a local lighting rental company for a motion picture being filmed at a particular location. An algorithm then analyses and selects, or determines 205, equipment to supplement or compensate for the ambient lighting for the scene from the database of available equipment. At decision point 206, if the available equipment cannot meet the requirements, then the software informs the user and suggests that either the lighting requirements or the available equipment be modified. The target color characteristic values, equipment and any equipment, associated parameters are recorded 207 in a database to be used during the base setup 208 for the actual scene illumination.

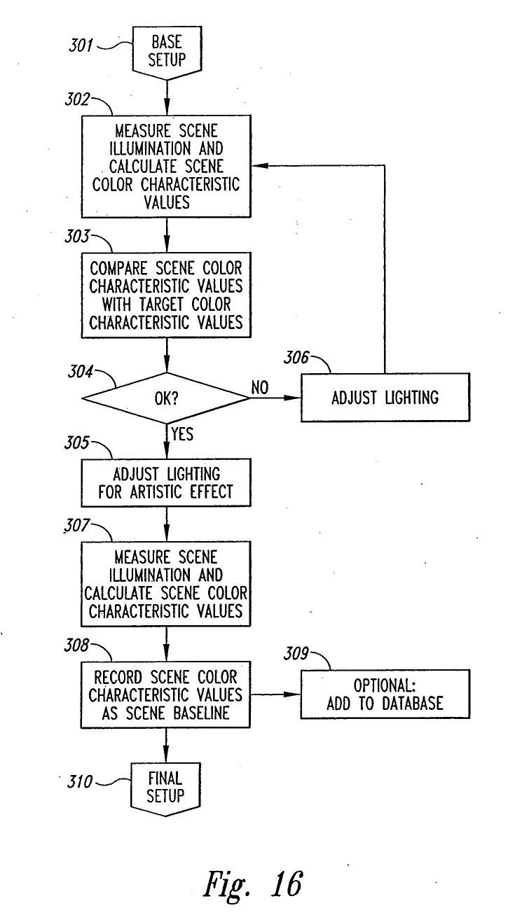

FIG. 16 is a flow chart depicting an embodiment of an algorithm of the computer implemented programming for setting up the illumination at a scene to try to reproduce a desired illumination for human viewing. After the equipment defined in the equipment selection algorithm, FIG. 15, is set up, the base setup algorithm 301 is initiated. The scene is illuminated and the scene illumination is measured. The color characteristics of the scene illumination are calculated 302, for example using the CIE XYZ tristimulus values or color coordinates for the illumination. The software then analyzes the lighting by comparing 303 these values to the desired or target values and determines the degree or amount of difference and whether adjustment is desired. The software adjustment algorithm then determines at decision point 304 whether adjustment is required to bring the lighting within the target values. If adjustment is required, automated or manual adjustment 306 occurs. If desired, the lighting can be adjusted for specific purposes such as artistic effect 305 even if the lighting is within the range of the target values. After adjustment, the software repeats the measurement and analysis. If the actual relative color characteristic values of illumination at the desired scene are not within the range of automatic control the software notifies the user and suggests manual adjustment 306; the operator can be prompted by audible or visual indicators. If the actual relative color characteristic values of illumination of the scene are acceptable then the scene illumination is measured 307 and recorded 308, added to a database 309 if desired, and then final setup 310 is performed.

These recorded values can also be used for other effects. For example, in this and certain other aspects of the invention, the systems, methods, databases, etc., herein can be used to control the apparent illumination in computer-generated images such as computer-generated pictures/films. When the desired effect is achieved, the scene illumination is then measured and the characteristic color values are recorded as the scene baseline values. These may be stored in a database of scene information. Both computer-generated scene (or other artificial scene) lighting information and actual scene lighting information can be used to reenact or reshoot a scene, or for special effects to match computer generated effects to real filmed scenes, or otherwise as desired.

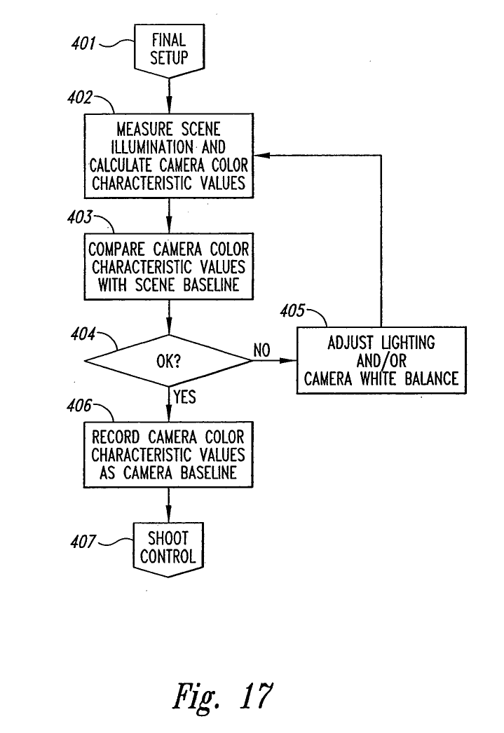

FIG. 17 is a flow chart depicting an embodiment of an algorithm of the computer implemented programming for the final setup of illumination for a scene that is being recorded by a camera or other imaging device. Following the baseline setup procedure, the program enters the final setup procedure 401. The scene illumination is measured and analyzed 402 using the characteristic tristimulus response functions or other response function of the imaging device. The analysis algorithm determines 403 if there is any adjustment desired for the lighting or to the camera for the imaging device to accurately record the scene. At decision point 404 if adjustments are desired the software performs automatic adjustment or advises the user to perform manual adjustment 405. When no further adjustments are desired, the characteristic illumination values are recorded 406 as camera baseline values for the scene being recorded. The scene can then be shot or continue shooting 407.

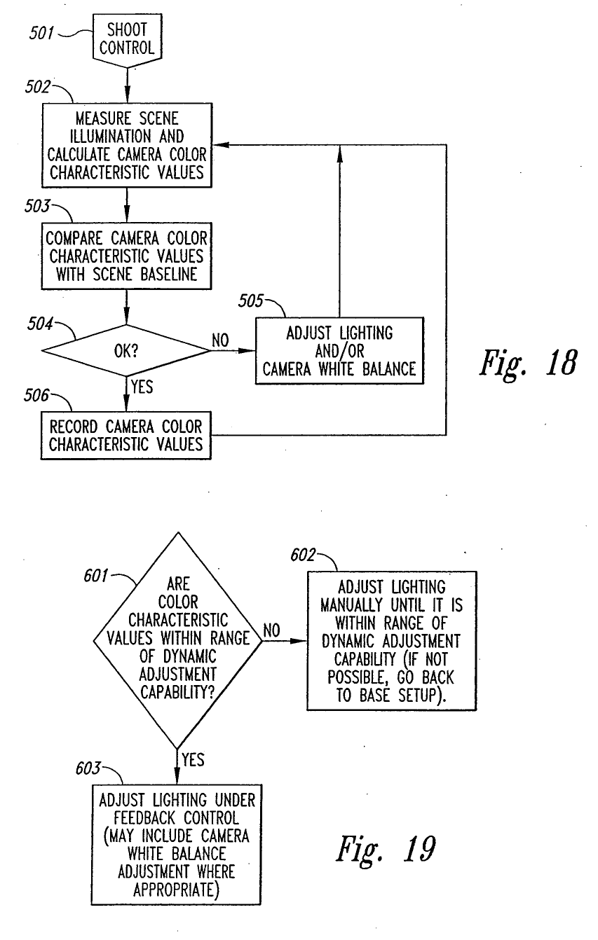

FIG. 18 is a flow chart depicting an embodiment of a film shoot control algorithm 501 that maintains constant color during the viewing or recording of a scene. As the scene is being filmed ambient lighting conditions may vary due to changes in the relative position of the sun or moon or to environmental or other effects. At the request of the operator or automatically, the software measures the scene illumination and calculates the actual relative color characteristic values 502 using the tristimulus response or other response function of the imaging device. The software compares this to the camera baseline value 503 or other target relative color characteristic values for the scene being recorded and if appropriate 504 initiates adjustment 505, automatic or manual, of lighting or imaging device white balance. The system then records 506, if desired, the characteristic camera values and any adjustments in a database for later reference.

FIG. 19 is a flow chart decision tree depicting a portion of an embodiment of an algorithm of the computer implemented programming for adjusting the illumination after measurement of the tristimulus values. The algorithm step of adjustment of illumination comprises algorithms for comparing an adjustment to the available range of automated adjustments 601 to determine if automated adjustment is possible 603 and then if possible to select an appropriate method of adjustment and if not possible 602 comparing the automated adjustment to the range of manual adjustments in combination with automated adjustments and recommending an appropriate combination of manual and automated adjustments.

### Additional General Discussion.

Turning to some additional discussion of various aspects and embodiments of the invention, one embodiment of the invention comprises several components to measure or control illumination characteristics.

An image recording of a scene or object is an array of information that represents the light emitted from the scene or object. The recording can be made by illuminating the scene or object with a light source or similar image-producing source, collecting the resulting image by a lens or other optical device, and focusing the image onto a photosensitive surface/element such as film or a pixelated detector.

In one embodiment, light for the scene being imaged can be measured using a spectroradiometric measurement unit comprising a calibrated spectrometer connected to a light input port, typically by a light guide such as a flexible fiber optic, a liquid light guide, or other optical relay system. The spectrometer or other spectral measurement device can have a wavelength resolution better than about 5 or 10 nm, and is typically operably connected to a system controller by a connector system. The connector system may, for example, comprise an electrical cable, fiber optic cable, analog or digital radio transmitter-receiver, free-space optical link, microcomputer controlled interface, or any other system to communicate data between the measurement unit and the system controller.

The system controller can be a commercially available computer and can comprise associated peripheral equipment, operating system software, measurement system software and measurement system control and analysis software.

The computer-implemented programming comprises algorithms or other programming to control the spectrometer data acquisition parameters, the transfer of data from the spectrometer, and the processing and analysis of the spectrometer data. It may further comprise algorithms for dynamic control of light sources. Algorithms are a set of rules and/or a sequence of procedures implemented in software. Control of the spectrometer or other system devices such as wavelength specific lamps indicates software algorithms that cause the computer to transmit or receive signals that the report status of, or initiate actions at, the device. The spectrometer measurement data can, in some embodiments, comprise an array of numbers representing the intensity of light impinging on a detector element positioned to receive light from a particular wavelength range. Alternatively, the light of a particular wavelength or wavelength range can be selectively attenuated, amplified or otherwise modified until a detector reaches a null value. The degree of attenuation or modification can be recorded and used to create an array of values characteristic of the relative wavelength distribution of the light, which includes the absolute intensity at the various wavelengths of light. In one embodiment, light entering the spectrometer encounters a wavelength dispersive optical element that distributes the light by wavelength across a detector array. The detector array converts the optical energy of the photons striking the detector into electrical energy.

The detector elements can be calibrated for a given wavelength or wavelength band of light by injecting light from a source of known discrete wavelengths, such as a mercury-argon lamp, into the detector. A discrete wavelength of light is light of a particular energy level. In a light source such as a mercury-argon lamp, the discrete wavelength of light is emitted from a specific electron transition of a particular element or molecule, and is typically described by the wavelength of the light in nanometers. A wavelength band or region of light is a contiguous group of such discrete wavelengths, typically about 10 to 100 nanometers or less; the region indicates photons with wavelengths bounded by a shorter and a longer limiting wavelength or upper and lower limiting energy level. In some embodiments, wavelength band sizes can be about 2, 20, 25, 30, 40, 50, or 100 nm. Such discrete wavelength sources are commercially available from manufacturers such as Ocean Optics of Dunedin, Fla. The measurement software wavelength calibration algorithm can use mathematical regression techniques or other comparative techniques to calculate wavelength range values for each detector element. After the wavelength response of the spectrometer is calculated the measurement software can calibrate the intensity response of the detector at each nominal measurement wavelength. The nominal measurement wavelength can be the mean wavelength of the wavelengths impinging on a given detector element.

The detector can be calibrated for intensity by acquiring a dark spectrum over a specific interval of time. The dark spectrum is a data array that represents the signal response of the spectrometer detector elements when no light is introduced. Light is then introduced to the measurement device from a calibrated source. The calibrated source typically emits a smoothly varying spectrum of light of known intensity at a range of wavelengths. Such sources are commercially available from manufacturers such as Gamma Scientific of California. The measurement software acquires spectral data from this source for the same specific interval of time as the dark spectrum and then the calibration software subtracts the dark spectrum from the intensity calibration spectrum and then calculates an intensity calibration factor for each wavelength element. The intensity calibration software can also adjust the intensity calibration factor for a range of measurement integration times, to effectively extend the dynamic range of the measurement module. The measurement device is preferably used for measurements once it is wavelength and intensity calibrated.

If desired, the user can initiate a scene measurement after the measurement system and the device have had time to reach environmental equilibrium. The measurement software then acquires measurement data. As with other aspects of the invention, if desired a threshold determination can be made, for example by an auto-ranging algorithm that can evaluate the data to determine if the measurement is of sufficient signal strength; if not then the algorithm adjusts measurement integration time until the signal is suitable or an error code is generated. The light source or measurement system is then either turned off or shuttered and the user initiates a dark spectrum or background measurement with the same integration time as for the light source measurement. Alternatively, the dark spectrum or background measurement may be acquired at another time either prior to or after the measurement and stored in a database for use when desired. The measurement algorithm then subtracts the background measurement from the light source measurement and applies the wavelength and intensity calibration factors. The measurement data is then stored in an electronic database for analysis.

The analysis software compares characteristics of the measurement spectra to predetermined characteristics that define an acceptable quality measurement. Such features may include, but not be limited to, signal magnitude, signal-to-noise ratio, relative distribution of wavelengths, and other features. Analysis can comprise comparing a measurement feature to acceptable upper or lower threshold values for that measurement or applying a linear discriminant function, or a neural network discriminant function, to a set of measurement features. If the measurement is not considered acceptable the measurement is flagged in the electronic database and the user is notified of the failure and requested to take appropriate action such as taking another measurement or modifying the lighting conditions.

If the measurement is considered acceptable, the analysis software compares the values of characteristic features of the measurement spectra to threshold values of features that identify acceptable performance levels for the light source or scene illumination being measured. If desired, these values are presented to the user, for example via the system controller display, and are recorded or utilized in the device database. Any failures to meet acceptable performance levels for the light source or scene illumination being measured are identified and can be reported to the user.

The analysis software can then compare the measurement to previous measurements of the scene and produces a report that records and presents scene illumination characteristics.

The analysis software can analyze the difference(s) between the measured scene illumination characteristics and the desired scene illumination characteristics and determines appropriate changes to the scene illumination to correct the actual scene illumination to a desired scene illumination. The software compares the desired changes to a database of available remedies and determines a desired solution or remedy. If desired, if the remedy is within the range of remedies that can be initiated automatically under computer control the control software initiates those remedies. Alternatively the remedy can be implemented manually. If the desired remedy includes manual intervention, the software alerts the operator, and may recommend the nature of that intervention.

Available remedies will vary depending on the range and capabilities of lighting equipment available. A low-budget film may have unsophisticated lighting and only manual interventions might be available. A high-budget film may have completely automated lighting with all illumination under computer control. A medium-budget film may have some automated and some manual remedies available. The software provides algorithms for and databases of available remedies that can be entered or selected by the operator. Lighting remedies include but are not limited to altering the intensity of a light source or altering the wavelength distribution of a light source or both.

Altering the intensity of an illumination source can include placing a neutral density filter in between the source and the scene, adjusting an iris or other device to place a limiting aperture in the path of the lamp that reduces the amount of light that can pass from the lamp to the scene, or adjusting the current or voltage to an electrically operated lamp or the gas or fuel supply to fueled types of lamps. Polarizing filters, partially reflective mirrors or beam splitters, variable reflective devices such as digital micro-mirror devices or reflective screens may also be used to vary wavelength and/or intensity of illumination. See, e.g., U.S. patent application entitled Apparatus And Methods Relating To Wavelength Conditioning Of Illumination, filed Jan. 31, 2002, Ser. No. 10/061,966. Distance between the source and the scene can be varied to reduce or increase illumination intensity. Many of the above methods can be implemented under automated computer software control.

Altering the wavelength distribution of energy in a light source will change the way color is perceived or detected and recorded by an imaging device. This can be accomplished by placing wavelength selective optical filters such as interference filters or absorbent glass; plastic or other transparent material filters in between the source and the scene being illuminated or by employing wavelength dispersive elements such as prisms, diffraction gratings such as reflective diffraction gratings, transmission diffraction gratings, or variable wavelength optical filters, or mosaic optical filters, in conjunction with movable slits or spatial light modulators such as digital micro-mirrors or liquid crystal spatial light modulators or other devices for selecting and controlling the relative wavelength distribution of energy in a light source.

The additive nature of light allows the combination of multiple light sources. Illumination from light sources that have a narrow range of wavelength emission and therefore a particular color can be mixed with white light sources or other narrow wavelength sources. It can also allow white light sources equipped with optical filters that limit their wavelength of emission to be mixed in various combinations.

In practice all of the above can be used for illuminating scenes, in particular for scenes that are filmed or photographed. This invention comprises software, devices and systems for creating and adjusting this illumination under automatic control and with measurement feedback to verify the accuracy of the adjustments, and can record lighting conditions during filming to facilitate re-shooting scenes, post-production color processing, and image processing operations such as “color timing” or special effects adjustments.

Photographic materials such as still camera or cine-camera film are designed to reasonably render color under specific illumination. Video devices such as CCD cameras or CMOS cameras also have particular color rendering characteristics associated with specific types of illumination. The manufacturer usually provides the spectral response characteristics of the film or device. Typically these refer to the two primary reference light sources: Daylight (5500 Kelvin) and Tungsten (3200 Kelvin).

Thus, in one aspect the present invention provides methods, automated or manual, that control the relative color characteristic values of scene illumination at a scene. The methods can comprise: measuring actual relative color characteristic values of illumination at the scene to provide measured relative color characteristic values; automatically comparing in at least one controller the measured relative color characteristic values with target relative color characteristic values stored in at least one computer-readable database, which can be a relational database if desired; automatically determining in the at least one controller whether there is at least one substantial difference between the measured relative color characteristic values and the target relative color characteristic values; and adjusting the illumination characteristics from at least one light source illuminating, the scene, or at least one imaging device recording the scene, to provide improved illumination comprise improved relative color characteristic values in the scene illumination that more closely match the target relative color characteristic values.

The methods can further comprise storing the measured relative color characteristic values in at least one computer-readable medium, and the adjusting can be performed automatically. The methods can comprise applying tristimulus or other multistimulus functions for the various relative color characteristic values and for determining at least one appropriate spectral change to correct for the at least one substantial difference between the various relative color characteristic values to provide the improved illumination. The methods can comprise assessing at least one available remedy from a database of available remedies to correct for the at least one substantial difference, and can selectively increase or decrease a substantial amount of red, blue, green or other desired light in the scene illumination.

The methods can further comprise recording the improved relative color characteristic values as a baseline illumination value, and if desired comparing a later-obtained measurement of the relative color characteristic values of the scene illumination against the baseline illumination value to determine if the later-obtained measurement varies more than a threshold level from the baseline illumination value. If the later-obtained measurement varies more than the threshold level from the baseline illumination value, then the scene illumination can be adjusted to bring the relative color characteristic values within the threshold level.

Methods of making a database can comprise target relative color characteristic values for a desired geographic position, a desired date and time, an environmental condition such as cloudiness, rain, dust, humidity, temperature and shade, and glare. The methods can also use such a database for selecting target relative color characteristic values for a scene illumination, comprising reviewing appropriate relative color characteristic values in the database, identifying a target appropriate relative color characteristic value corresponding to the target relative color characteristic values, and selecting the target appropriate relative color characteristic value.

Methods of identifying illumination equipment to illuminate a desired scene can comprise providing target relative color characteristic values for the desired scene; providing a computer-readable database comprise known relative color characteristic values for a plurality of illumination equipment at least one of which can be able to supply the target relative color characteristic values; comparing the target relative color characteristic values to the database; and, identifying acceptable illumination equipment able to supply the target relative color characteristic values. The illumination equipment can be selected, for example, from the group consisting of a white light source, a tunable light source, a light filter, a wavelength dispersive element, a spatial light modulator, and a light source emitting a single wavelength or a wavelength band limited to single color of light. The target relative color characteristic values can be obtained from a database as discussed herein.

Methods of establishing scene baseline values comprising target relative color characteristic values of illumination of a scene illumination can include: illuminating a scene; measuring actual scene illumination; calculating the relative color characteristic values of the actual scene illumination to provide measured relative color characteristic values; and recording the measured relative color characteristic values in a computer-readable medium as scene baseline values. The methods can comprise, between the calculating and the recording, comparing the measured relative color characteristic values to target relative color characteristic values and determining whether there is at least one substantial difference and adjusting the actual scene illumination until the actual scene illumination surpasses a desired value to provide an acceptable actual scene illumination, and the recording can comprise recording the acceptable actual scene illumination as scene baseline values.

Computer-implemented methods of adjusting illumination of a scene after measurement of unacceptable tristimulus or other multistimulus values of relative color characteristic values of the scene can comprise: providing the measurement comprising the unacceptable multistimulus values; comparing the unacceptable multistimulus values to a range of dynamic adjustment capabilities of illumination equipment that are illuminating the scene; and automatically or manually adjusting the illumination equipment under feedback control until the multistimulus values of the scene reach an acceptable level.

The present invention also provides computer-implemented programming that performs the methods herein, computers and other controllers that comprise computer-implemented programming and that implement or perform the methods herein, and systems for illuminating of a scene comprise: a spectral sensor and a controller as discussed herein operably connected to the spectral sensor, and preferably at least one light source operably connected to the controller and capable of variably affecting the spectral composition of the illumination. The systems can be hardwire, wireless or otherwise as desired, and the light sources can include at least one light source that emits primarily red light, at least one light source that emits primarily green light, and at least one light source that emits primarily blue light, or at least one white light source, or a tunable light source, either or both in terms of intensity or wavelength.

From the foregoing, it will be appreciated that, although specific embodiments of the invention have been discussed herein for purposes of illustration, various modifications may be made without deviating from the spirit and scope of the invention. Accordingly, the invention is not limited except as by the appended claims.

1. An automated method that controls relative color characteristic values of a scene illumination at a scene, comprising:
measuring actual relative color characteristic values of illumination at the scene to provide measured relative color characteristic values;
automatically comparing in at least one controller the measured relative color characteristic values with target relative color characteristic values stored in at least one computer-readable database;
automatically determining in the at least one controller whether there is at least one substantial difference between the measured relative color characteristic values and the target relative color characteristic values;
adjusting illumination characteristics from at least one light source illuminating the scene to provide improved illumination comprising improved relative color characteristic values in the scene illumination that more closely match the target relative color characteristic values;
wherein the method further comprises storing the measured relative color characteristic values in at least one computer-readable medium, and the adjusting is performed automatically.

2. (canceled)

3. The method of claim 1 wherein the target relative color characteristic values correlate to the relative color characteristics of a specific geographic location comprising information relating to latitude, longitude and altitude of the location.

4. The method of claim 1 wherein the target relative color characteristics correlate to at least one of date, time of day, and angle of solar or lunar illumination.

5. The method of claim 1 wherein the target relative color characteristics correlate to at least one environmental condition selected from the group consisting of cloudiness, rain, dust, humidity, temperature and shade.

6. The method of claim 1 wherein the target relative color characteristics correlate to at least one artificial light source.

7. The method of claim 1 wherein the method further comprises applying tristimulus functions to the measured relative color characteristic values and the target relative color characteristic values to determine whether there is the at least one substantial difference between the measured relative color characteristic values and the target relative color characteristic values, wherein the method further comprises applying tristimulus functions to determine at least one appropriate spectral change to correct for the at least one substantial difference between the measured relative color characteristic values and the target relative color characteristic values to provide the improved illumination.

8-12. (canceled)

13. The method of claim 1 wherein the measured relative color characteristic values are transmitted via wireless to the controller.

14. The method of claim 1 wherein the method further comprises recording the improved relative color characteristic values as a baseline illumination value.

15. The method of claim 14 wherein the method further comprises comparing a later-obtained measurement of the relative color characteristic values of the scene illumination against the baseline illumination value to determine if the later-obtained measurement varies more than a threshold level from the baseline illumination value.

16. The method of claim 15 wherein the method further comprises, if the later-obtained measurement varies more than the threshold level from the baseline illumination value, then automatically adjusting the scene illumination to bring the relative color characteristic values within the threshold level.

17. An automated method that controls relative color characteristic values of a scene illumination, comprising:
measuring actual relative color characteristic values of illumination at the desired scene to provide measured relative color characteristic values and storing the measured relative color characteristic values in at least one computer-accessible database;
automatically comparing in at least one controller the measured relative color characteristic values with target relative color characteristic values stored in at least one computer-readable database;
automatically determining in the at least one controller whether there is at least one substantial difference between the measured relative color characteristic values and the target relative color characteristic values;
adjusting recording characteristics of at least one recording imaging device recording an image of the scene to provide improved apparent illumination comprising improved relative color characteristic values of the scene illumination as recorded by the recording imaging device that more closely match the target relative color characteristic values;
wherein the method further comprises storing the measured relative color characteristic values in at least one computer-readable medium, and the adjusting is performed automatically.

18. (canceled)

19. The method of claim 17 wherein the target relative color characteristic values correlate to the relative color characteristics of a specific geographic location comprising information relating to latitude, longitude and altitude of the location.

20. The method of claim 17 wherein the target relative color characteristics correlate to at least one of date, time of day, and angle of solar or lunar illumination.

21. The method of claim 17 wherein the target relative color characteristics correlate to at least one environmental condition selected from the group consisting of cloudiness, rain, dust, humidity, temperature and shade.

22. The method of claim 17 wherein the target relative color characteristics correlate to at least one artificial light source.

23. The method of claim 17 wherein the method further comprises applying tristimulus functions to the measured relative color characteristic values and the target relative color characteristic values to determine whether there is the at least one substantial difference between the measured relative color characteristic values and the target relative color characteristic values, wherein the method further comprises applying tristimulus functions to determine at least one appropriate spectral change to correct for the at least one substantial difference between the measured relative color characteristic values and the target relative color characteristic values to provide the improved illumination.

24. (canceled)

25. The method of claim 17 wherein the method further comprises assessing at least one available remedy from a database of available remedies to correct for the at least one substantial difference.

26-27. (canceled)

28. The method of claim 17 wherein the measured relative color characteristic values are transmitted via wireless to the controller.

29. The method of claim 17 wherein the method further comprises recording the improved relative color characteristic values as a baseline illumination value.

30. The method of claim 29 wherein the method further comprises comparing a later-obtained measurement of the relative color characteristic values of the scene illumination against the baseline illumination value to determine if the later-obtained measurement varies more than a threshold level from the baseline illumination value, wherein the method further comprises, if the later-obtained measurement varies more than the threshold level from the baseline illumination value, then automatically adjusting the recording of the scene to bring the relative color characteristic values within the threshold level.

31. (canceled)

32. A method of making a database comprising target relative color characteristic values for a desired geographic position, a desired date and time, comprising:
determining a first wavelength dependent energy distribution based on latitude, longitude, altitude, date of year and time of day, thereby providing an angle of solar illumination incident on the scene and an estimate of the quantity of atmosphere the solar illumination traverses;
calculating appropriate relative color characteristic values of the wavelength dependent energy distribution using multistimulus values for the first wavelength dependent energy distribution to provide target relative color characteristic values;
recording the target relative color characteristic values as the database in a computer-readable database;
wherein the database further comprises target relative color characteristic values for desired environmental conditions, and the method further comprises:
determining a second wavelength dependent energy distribution based on at least one environmental condition selected from the group consisting of cloudiness, rain, dust, humidity, temperature and shade.

33-44. (canceled)
